(19) United States
(12) Patent Application Publication
(10) Pub. No.: US 2009/0301277 A1
(43) Pub. Date: Dec. 10, 2009

(54) Saw With Moveable Material Support Surface

(76) Inventors: Aleksander Ipatenco, Belton, SC (US); Jay Aaron Goddard, Easley, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/135,700

(22) Filed: Jun. 9, 2008

(51) Int. Cl. B26D 1/143; B26D 7/27; B26D 5/08

(52) U.S. Cl. 83/471; 83/522.16; 83/581

(57) ABSTRACT

A miter saw is described that includes a base, a table rotatably coupled with the base, and a saw unit pivotally coupled with the base and including a motor and a saw blade coupled with the motor. At least one material support surface is moveable with respect to the base.

### BACKGROUND OF THE INVENTION

This invention relates to a miter saw with a moveable material support surface. The miter range of conventional miter saws is generally limited by the size of the turntable that is used to support the work piece. However, it is often desirable to make miter cuts that fall outside the miter range that is offered with conventional miter saws. Accordingly, a miter saw that overcomes these deficiencies is provided.

### SUMMARY OF THE INVENTION

The scope of the present invention is defined solely by the claims and is not affected to any degree by statements within this summary. Briefly stated, a miter saw is provided with at least one moveable material support surface. The miter saw includes a base, a saw unit pivotally coupled with the base that comprises a motor and a saw blade coupled with the motor, and a table rotatably coupled with the base. The material support surface is moveably associated with the base, and the material support surface may also be provided with a locking mechanism to lock the support surface in a desired position.

### BRIEF DESCRIPTION OF THE FIGURES

The invention may be better understood with reference to the following figures and detailed description. The components in the figures are not necessarily to scale, emphasis being placed upon illustrating the principles of the invention.

FIG. 1 is a perspective view of a miter saw incorporating one embodiment of the present invention;

FIG. 2 is a perspective view of the miter saw of FIG. 1 when a material support surface is moved from its default position;

FIG. 3 is a view of one embodiment of a locking mechanism for a material support surface;

FIG. 4 is a close-up, partial cross-sectional view of the locking mechanism shown in FIG. 3; and

FIG. 5 is a partial cross-sectional view of a bevel lock and detent system for a miter saw of the present invention.

### DETAILED DESCRIPTION OF THE PREFERRED EMBODIMENTS

By way of introduction, the embodiments described below include a miter saw with at least one moveable material support surface. The miter saw includes a base and a saw unit pivotally coupled with the base. The saw unit includes a motor and a saw blade coupled with the motor. A table is rotatably coupled with the base. At least one material support surface is moveably associated with the base. A locking mechanism may be provided to selectively lock the support surface in position. The phrase “coupled with,” as used herein, means coupled either directly or indirectly via one or more intervening elements.

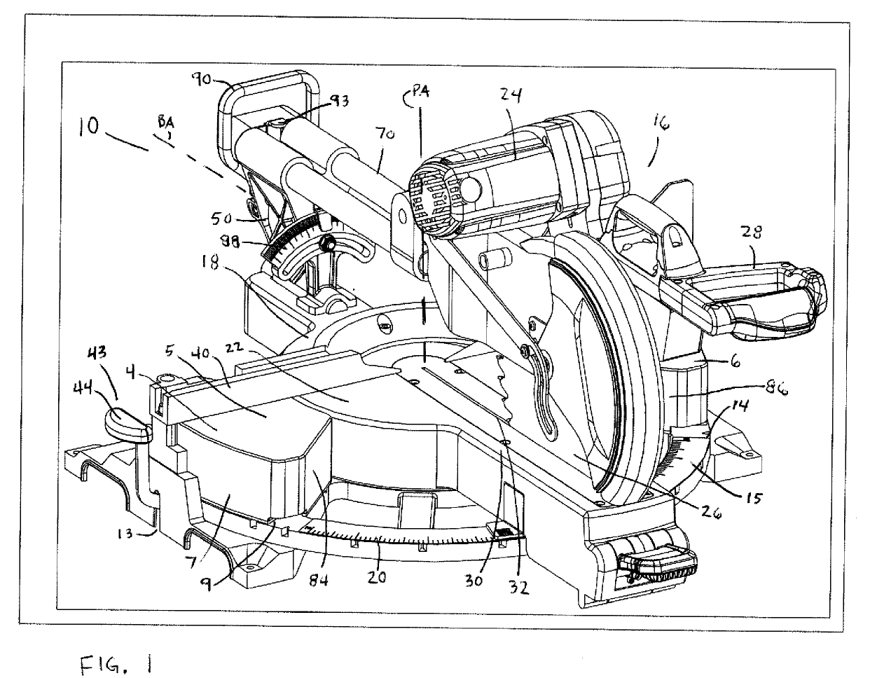

FIG. 1 shows a perspective view of a miter saw 10 incorporating the novel features of the present invention. The saw 10 includes a base 14 and a table assembly 18 that may be used to support a work piece and a fence assembly 40. The fence assembly 40 may include a fixed fence fixedly attached to the base 14 and a slideable fence slidably attached to the fixed fence. A second fence may also be provided in a fixed manner to the base 14. The fixed fences are typically co-planar. The table assembly 18 is coupled with the base 14 for pivoting movement about a generally vertical miter axis PA. The table assembly 18 may be formed generally in the shape of a circle. The base 14 may be formed generally in the shape of a semi-circle and may be formed with an arc-shaped outer edge 15 formed with an upper surface. The upper surface of the outer edge 15 of the base 14 may be provided with a miter scale 20. The miter scale 20 can provide an indicator so that the operator can position the miter saw 10 at a desired angle to perform a miter cut.

In one embodiment, the range of the miter scale 20 extends from −70 degrees to +70 degrees from right to left in FIG. 1. The scale 20 may have any suitable increments. In FIG. 1, the table assembly 18 is set in the default, centered position that corresponds with 0 degrees on scale 20. It will be understood that alternative ranges and increments can be utilized. For example, the range of scale 20 may extend from −90 degrees to +90 degrees, as well as other integer ranges, such as from −80 degrees to +80 degrees, −60 degrees to +60 degrees, −50 degrees to +50 degrees. In addition, the scale 20 can display integer increments from about one degree to about 10 degrees, depending on the size of the base 14 of the miter saw 10, along with the degree of accuracy that is desired by the operator of the miter saw 10. It is also contemplated that the scale 20 display fractional increments from about 0.1 degree up to about 1 degree, including 0.2, 0.25, 0.3, 0.4, 0.5, 0.6, 0.7, 0.75, 0.8, and 0.9 degrees.

It is also contemplated that the scale 20 be removable and to contain a display on both sides of the scale. For example, on one side of the scale 20, the displayed range may be from about 0° to about 70° while on the other side, the displayed range may be from about 90° to about 20°.

It is also contemplated that the scale 20 be in the form of a digital scale such that a digital output is visible from the top of the base 14 near its edge.

The saw 10 includes a saw unit 16 that includes a motor 24 operable to drive a saw blade 26 to cut a work piece supported on the table assembly 18. The saw unit 10 is coupled with the table assembly 18 for generally linear sliding movement by a sliding support assembly. In one embodiment, the sliding support assembly generally includes slide tubes 70 supported for sliding movement relative to the table assembly 18. The saw unit 10 is supported by the slide tubes 70 for movement with the slide tubes 70 relative to the table assembly 18. The slide tubes 70 are preferably coupled with the table assembly 18 via the bevel support member 50 that is located on the table assembly 18. Of course, it is understood that the features of the present invention are not limited to the described sliding miter saw and that the description of these features of the sliding miter saw are simply to provide perspective.

As shown in FIG. 1, the motor 24 and the saw blade 26 are coupled to the table assembly 18 for pivoting movement with the table assembly 18 relative to the base 14 to allow the saw blade 26 to perform various angled miter cuts on a work piece supported on the table assembly 18. The motor 24 and the saw blade 26 are coupled to the table assembly 18 for movement relative to the table 18 between a raised, non-cutting position and a lowered, cutting position. A handle 28 is coupled with the saw unit 16 to enable the operator to raise and lower the saw blade 26 to engage the work piece.

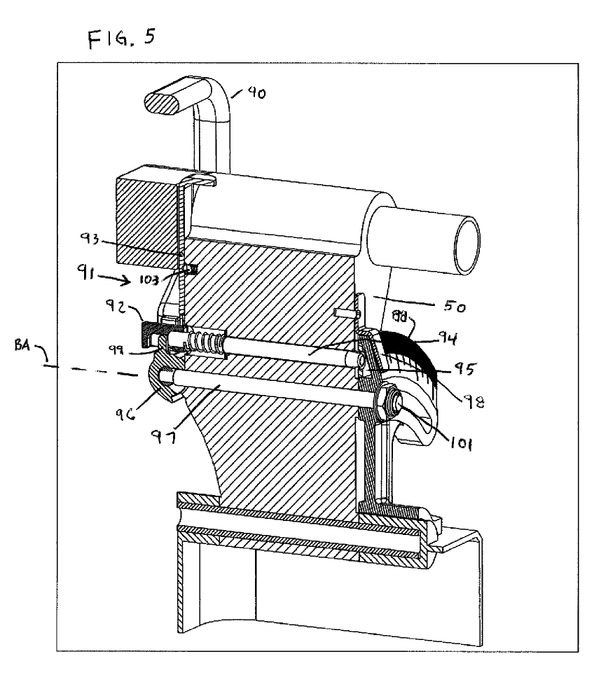

The motor 24 and the saw blade 26 may be coupled to the table assembly 18 for pivoting movement about a bevel axis BA to allow the saw blade 26 to perform bevel cuts on a work piece supported on the table assembly 18. The miter saw may also be provided with a locking mechanism 91, as shown in FIG. 5 that allows the blade 26 to pivot about the bevel axis BA to a desired angle and to lock the saw blade 26 at the desired bevel angle. The locking mechanism 91 allows bevel cuts in conjunction with extreme miter angles without interference from the fence assembly 40. The locking mechanism 91 also enables the bevel position to be locked with one hand, which is an advantage for the operator as the saw 10 is being operated.

The locking mechanism 91 includes a bevel handle 90 that may be rotatably coupled with the bevel support 50 and is used to rotate the saw blade 26 about bevel axis BA. The locking mechanism 91 also includes a detent carrier 92, a detent override plate 93, a detent pin 94, a detent plate 95, a cam lock 96, a lock pin 97, a bevel indicator 98, and a bevel scale 88. The lock pin 97 operates to prevent the saw blade 26 from being able to bevel. The operator can manually adjust the locking force applied by the lock pin 97 by adjusting a locking nut 101 that is typically located on one end of the lock pin 97. The locking force of the lock pin 97 is also controlled by the cam lock 96 and by the detent carrier 92, the detent override plate 93, the detent pin 94, and the detent plate 95. The cam lock 96 applies a clamping force on the lock pin 97. The operator can release this clamping force by pulling (or rotating) the bevel handle 90 in a direction away from the saw 10. The movement (or rotation) of the bevel handle 90 concurrently rotates the cam lock 96, which only partially frees up the saw blade 26 to bevel because the detent pin 94 is still engaged. The cam lock 96 typically is released after the bevel handle 90 is rotated away from the saw. The amount of rotation of the bevel handle 90 required to release the cam lock can be adjusted depending upon desired preferences. For example, the amount of rotation can be from about 5° to about 90°, although a rotation less than about 90° is desirable. Accordingly, it is contemplated to provide an amount of rotation from about 5° to about 45° and can be, for example from about 10° to about 25° or from about 15° to about 20°.

To release the detent pin 94, the operator can continue to rotate the bevel handle 90 approximately another 10 degrees. As the cam lock 96 continues to rotate, a vertical finger 99 that is located on the cam lock 96 will impact the rear surface of the detent carrier 92. This impact will cause the detent carrier 92 to move in a backward direction away from the saw 10. As the detent carrier 92 moves backward, the detent pin 94, which is typically spring-loaded, will be pulled clear of one of the openings in the detent plate 95 in which the detent pin 94 is normally located. Once the detent pin 94 is clear of the detent plate 95, the saw blade 26 will be completely free to rotate and bevel, as long as the operator continues to hold the bevel handle 90 with enough force to overcome the spring bias of the detent pin 94. When the saw blade 26 has been positioned at the desired bevel angle, the operator can release the force that is being applied to the bevel handle 90, allowing the bevel handle to move toward the saw 10 until the detent pin 94 contacts the detent plate 95 or settles into an opening in the detent plate 95. Finally, the operator can fully lock the saw blade 26 by pulling the bevel handle 90 towards the saw 10 until the cam lock 96 returns to its locked position.

A detent override plate 93 may also be provided for the situation where the desired bevel angle for the saw blade 26 is close to an angle at which the detent pin 94 fits within the openings in the detent plate 95. In such a situation, the operator will typically have difficulty locking the saw blade 26 at a very precise bevel angle because the spring-biased detent pin 94 will attempt to push the saw blade 26 away from the desired bevel angle and towards the opening in the detent plate 95.

When an operator encounters such a situation, the operator can push the detent override plate 93 down once the detent pin 94 is pulled clear of the openings in the detent plate 95. When the detent override plate 93 is pushed down, the override plate 93 will slide behind the detent carrier 92, not allowing the detent pin 94 to contact the detent plate 95. The use of the detent override plate 93 allows the saw blade 26 to move through the range of bevel angles without the need for the operator to also hold the bevel handle 90 back away from the saw 10 to overcome the spring bias of the detent pin 94. Once the operator positions the saw blade 26 at the desired bevel angle, the operator can lock the bevel handle 90 and the saw blade 26 in the preferred manner without any interference from the detent 94. When the operator requires the detent function again, the operator can pull up on the detent override plate 93, which will allow the detent pin 94 to spring back to its normal operating position. The detent override plate 93 is typically held in place with a spring-biased detent ball 103 that is located in the bevel support 50. However, alternative methods of securing the detent override plate 93 can be utilized, such as the use of a releasable latch coupled with the bevel support 50 that the operator can manually engage or disengage.

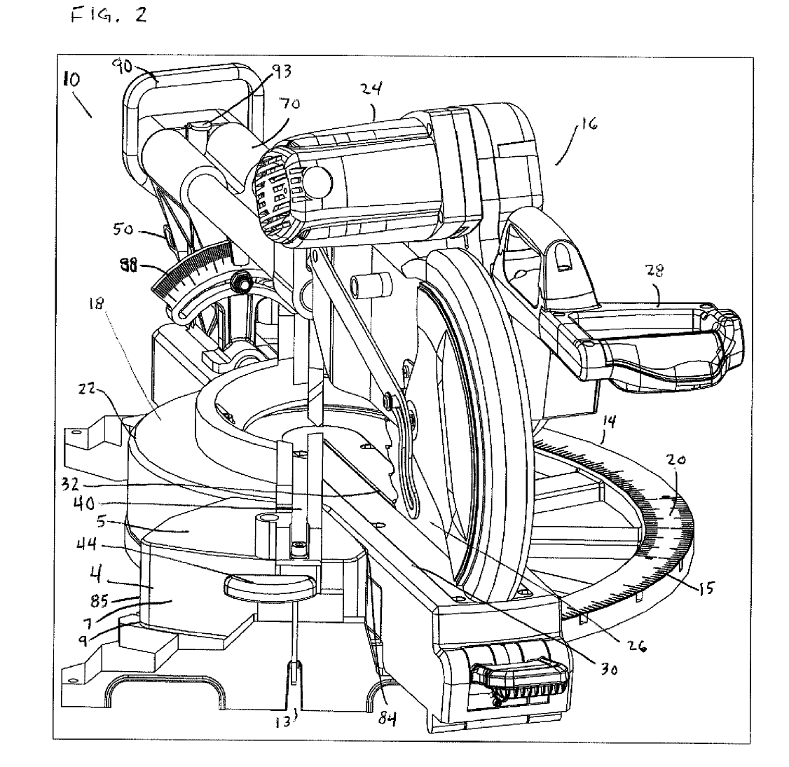

The bevel indicator 98 indicates how many degrees the saw blade 26 has been rotated, as indicated by its location on the bevel scale 88. In one embodiment, the range of the bevel scale 99 extends from −40 degrees to +40 degrees from right to left in FIGS. 1-2 with increments of one degree indicated on bevel scale 88. In FIGS. 1-2 and FIG. 5, the saw blade 26 is set in the default, centered bevel position that corresponds with 0 degrees on bevel scale 88. It will be understood that alternative ranges and increments can be utilized. For example, the range of bevel scale 88 may extend from −45 degrees to +45 degrees, as well as other integer ranges, such as from −35 to +35 degrees. In addition, the scale 20 can display integer increments from about one degree to about 10 degrees, depending on the size of the base 14 of the miter saw 10, along with the degree of accuracy that is desired by the operator of the miter saw 10. It is also contemplated that the scale 20 display fractional increments from about 0.1 degree up to about 1 degree, including 0.2, 0.25, 0.3, 0.4, 0.5, 0.6, 0.7, 0.75, 0.8, and 0.9 degrees.

The table assembly 18 includes a throat 30 that extends radially outward from the table assembly 18 beyond the outer edge 15 of the base 14. The throat 30 may have any suitable shape although typically it will be formed in the shape of a rectangle. The throat 30 will rotate concurrently with the table assembly 18. The throat 30, along with the table assembly 18, can be rotated about the base 14 to the right or to the left. FIG. 1 shows the table assembly 18 and the throat 30 in the default position. FIG. 2 shows the table assembly 18 and the throat 30 in its extreme left miter position, as the table assembly 18 and the throat 30 has been rotated as far left as possible. The table assembly 18 includes a table surface 22 upon which the work piece may rest. Additionally, the top surface of the throat 30 desirably lies in substantially the same plane as the top of the table surface 22. The throat 30 typically has an opening 32 into which the saw blade 26 can extend when the saw unit 16 is in its fully lowered position, as shown in FIG. 1. Alternatively, the opening 32 can be located in the table assembly 18, depending on the size of the table assembly 18 and/or the size of the saw blade 26.

The base 14 may include at least one material support to provide additional support so that the miter saw 10 is able to cut larger-sized work pieces. Another advantage associated with the use of at least one material support is that the size of the table 18 normally needed to cut large work pieces can be significantly reduced, which reduces the amount of raw material, preferably some type of metal or polymer, needed to construct the saw 10. Therefore, the weight of the saw will be reduced as well, making the saw easier to transport. The material support is typically formed in the general shape of a block-like structure. The block-like structure can be formed in a variety of shapes, such as rectangular, circular, and semi-circular. The material support is moveable with respect to the base 14 of the miter saw. In this regard, the material support may be removable with respect to the base or may be operatively associated with the base such that it is moveable with respect to the base.

The material support has a top surface 5 that lies generally in the same plane as the top surface 22 of the table assembly 18. As a result, the table surface 22 and the material support surfaces 4, 6 may cooperate to support a work piece. The material support also typically has a first side edge 84 and a second edge 85. The side edges 84, 85 are located opposite one another and are coupled with the top surface 5. In addition, the material support typically has a bottom surface 9 that is located opposite the top surface 5 and that is capable of contacting the base 14. The bottom surface 9 is also coupled with the side edges 84, 85. The material support also typically has a rear surface 7 that is located between the two side edges 84, 85 and coupled with both the top surface 5 and the bottom surface 9. This description is applicable to both material support surfaces 4, 6 that are shown in the embodiment that is shown in FIG. 1.

In one embodiment, the material support includes a first support surface 4 and a second support surface 6. The first support surface 4 and the second support surface 6 are independently coupled with the base 14 and are located opposite each other. Typically, the first support surface 4 and the second support surface 6 are located opposite each other and on either side of the throat 30. The material support surfaces 4, 6 are able to independently move along the periphery of the base 14.

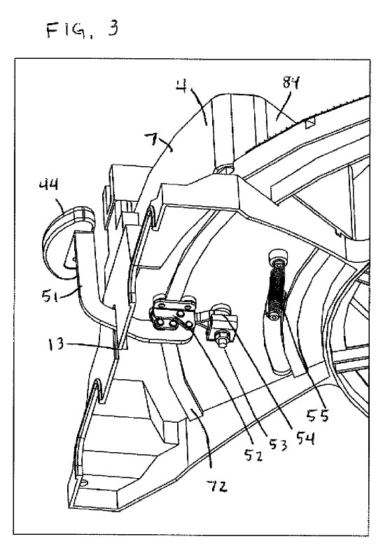

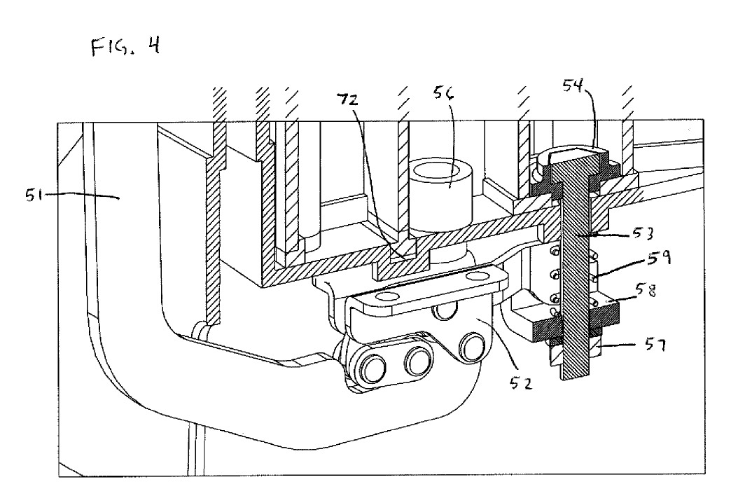

In one aspect, a groove 72 is provided in the base 14, as shown in FIGS. 3 and 4 to that the material support surfaces 4, 6 can move within the groove 72. The groove 72 may be arc-shaped or can be formed in other alternate suitable shapes, such as rectangular or circular. A separate groove 72 is provided for each material support surface 4, 6. Because the groove 72 associated with each material support surface 4, 6 operate in the same manner, only groove 72 is described. Alternatively, a plurality of grooves may be provided in the base 14 for each material support surface 4, 6. In addition, the size of the material support surfaces 4, 6 may be varied to accommodate either a larger or smaller miter saw. The size of the material support surfaces 4, 6 may be altered either by shortening or increasing the horizontal length of the support surfaces, or alternatively by shortening or increasing the vertical height of the support surfaces.

The support surface 4 has a first edge 84 and the support surface 6 has a first edge 86. Each first edge 84, 86 is located at a selected default miter setting. A suitable default setting is about +/−45 degrees, such as for example +/−47 degrees. It will be understood that alternative default miter settings can be used. For example, the default miter setting can be located within a range of about +/−40 degrees to about +/−55 degrees.

In one aspect, the first edge 84, 86 may interact with the throat 30 of the table assembly 18 so that the support surfaces 4, 6, respectively move as will be explained below. The first edge 84, 86 may also act as a guide to determine the miter setting of the support surfaces 4, 6, as the operator is able to determine what angular position on the miter scale 20 corresponds with the location of the first edge 84, 86.

Support surface 4 has a second edge 85 spaced from and opposite the first edge 84. Similarly, support surface 6 has a second edge (not shown) spaced from and opposite the first edge 86. The second edge 85 can define the furthest position of the support surface 4, 6 on the base 14. In one embodiment, the first edge 84 of the first support surface 4 is located at a position that corresponds with the 47 degree miter setting, and the first edge 86 of the second support surface 6 is located at a position that corresponds with the −47 degree miter setting.

As shown in FIG. 2, one aspect of accomplishing a miter cut that exceeds the selected default miter setting is shown. In this aspect, the table assembly 18 can be rotated until the throat 30 contacts the respective first edge 84, 86 of the support surface 4, 6. If the support surface 4, 6 is not locked in place, the throat 30 is configured to move the support surface 4, 6 along the periphery of the base 14. For example, if the table assembly 18 and the throat 30 are rotated to the left (as shown in FIG. 2), the throat 30 will contact the first edge 84 of the first support surface 4 at the miter setting of 47 degrees. If the table assembly 18 and the throat 30 are rotated to the right, the throat 30 will contact the first edge 86 of the second support surface 6 at a selected miter setting of −47 degrees.

For example, when the table assembly 18 is rotated to the left as shown in FIG. 2, the first support surface 4 moves as the miter throat 30 contacts the first edge 84 of the first support surface 4 at the miter setting of 47 degrees. The first support surface 4 continues to move up to a preferable setting of 23 degrees as the miter saw 10 is rotated to its preferable 70 degree maximum miter setting. As previously stated, the support surface 4 may be rotated up to a maximum miter setting of 90 degrees. This also happens to the second support surface 6 when the table assembly 18 is rotated to the right. The moveability and adjustability of the support surface 4, 6 increases the miter capacity of the miter saw 10, as the rotation of the table 18 is not limited by the presence of the support surface 4, 6.

It is also contemplated that each of the first support surface 4 and second support surface 6 may be moved by an operation other than by contact with the throat. For example, each of the surfaces 4, 6 may be moved by the user or indirectly by the throat 30.

A locking mechanism 43 may be operably associated with each material support surface 4, 6 to selectively lock the respective material support surface 4, 6 in a selected position. In general, the locking mechanism 43 cooperates with the material support surface 4, 6 along with the base 14 to secure the position of the material support surface 4,6 in relation to the base 14. The locking mechanism 43 is configured to operatively selectively lock one or both of the support surfaces 4, 6 in a selected position. The base 14 may include a slot 13 that is capable of receiving the locking mechanism 43. Any known locking mechanism may be used.

One embodiment of a locking mechanism is shown in FIGS. 3 and 4. A separate locking mechanism 44, 66 may be associated with each material support surface 4, 6. Each locking mechanism 44, 66 is coupled with the base 14 and the respective material support surface 4, 6 to selectively lock the support surface 4, 6 in a selected position. The first locking mechanism 44 is positioned to selectively lock the first support surface 4 when the first locking mechanism 44 is engaged. The second locking mechanism 66 is preferably positioned to secure the second support surface 6 when the second locking mechanism 66 is engaged. Because each locking mechanism 44, 66 associated with each material support surface 4, 6 operates in the same manner, only one locking mechanism 44 will be described.

FIG. 3 and FIG. 4 illustrate one embodiment of a locking mechanism 44 for the first support surface 4. The first locking mechanism 44 includes a handle 51 that is coupled with a bolt 53 through a link 52. One portion of the link 52 is coupled with a locking bolt 53 that has a head held within a carrier 54. The carrier 54 is preferably formed from plastic. The bolt 53 secures the support surface 4 to the base 14. In one embodiment, the locking handle 51 is moved in a first direction with respect to the support surface 4, 6 to loosen the locking bolt 53, which will unlock the first side support surface 4 so that it is capable of being moved. The locking handle 51 can be moved in a second direction to selectively secure the locking bolt 53 in a locked position so that the first support surface 4 is unable to move.

As can be seen in FIG. 3, the first support surface 4 is coupled with a return spring 55. A return spring (not shown) is also coupled with the second support surface 6. The return spring 55 is also coupled with the base 14 and acts to return the first support surface 4 to its default position (shown in FIGS. 1 and 3). For example, FIG. 2 shows the positioning of the first support surface 4 after the first support surface 4 has been moved to the left as a result of the throat 30 being rotated to the left to contact and move the first supports surface 4. However, when the throat 30 is rotated back to the right out of contact with the first support surface 4, the return spring 55 is biased to move the first support surface 4 back towards its default position, shown in FIG. 1.

FIG. 4 shows a close-up view of the bolt 53 that affixes the first support surface 4, the base 14, and the first locking system 44 to each other. The bolt 53 is kept under continuous tension by a compression spring 59 in order to keep the first support surface 4 from shaking or rattling when the miter saw 10 is being operated. The amount of force applied by the clamp 52 is easily adjusted by turning a nut 57, secured to the bottom of the bolt 53, which moves a clamp platform 58 up or down. Furthermore, the carrier 54 is provided to keep the bolt 53 from turning. As the first support surface 4 is moved, the bolt 53 stays stationary and the carrier 54 acts as a sliding bearing surface. The same construction is also present for the second support surface 6 and second locking system 66. To limit the movement of the support surface 4, 6, bumper stops may be provided on the base 14. As is shown in FIG. 4, bumper stops 56 are provided to keep the first support surface 4 from rotating beyond its intended limit. The bumper stops 56 may be formed from rubber, although alternative materials, such as plastic or metal, may be used to form the bumper stops 56.

Furthermore, alternative methods and embodiments of locking systems 44, 66 may be utilized to secure the side support surfaces 4, 6. For example, the side support surfaces 4, 6 can be secured with magnets secured to the base 14. Alternatively, a spring and detent system that cooperates with the side support surface 4, 6 and the base 14 can be utilized as a locking system. Another alternative to lock the side support surface 4, 6 is the use of screw knobs that are able to apply pressure on the side support surface 4, 6 that thus hold it in place. The screw knobs may be located above, below, or to the sides of the side support surface 4, 6 in any position as long as the screw knobs are able to contact and put pressure on the side support surface 4, 6 to lock them in place. The tension on the screw knobs can be adjusted to concurrently adjust the pressure that is exerted on the side support surface 4, 6.

Various embodiments of the invention have been described and illustrated. However, the description and illustrations are by way of example only. Many more embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light necessitated by the accompanying claims and their equivalents.

1. A miter saw comprising:
a. a base;
b. a saw unit pivotally coupled with the base;
c. a table rotatably coupled with the base; and
d. a material support surface selectively moveable with respect to the base.

2. The miter saw of claim 1 further comprising a locking mechanism to selectively secure the material support surface in a first position with respect to the base.

3. The miter saw of claim 1 further comprising a scale.

4. The miter saw of claim 3 wherein the scale is associated with an outer edge of the base.

5. The miter saw of claim 4 wherein the scale has a range of about −90 degrees to about +90 degrees.

6. The miter saw of claim 4 wherein an edge of the material support surface is positioned at a miter setting between about 40 degrees and about 55 degrees.

7. The miter saw of claim 6 wherein the edge of the material support surface is capable of moving within a range of about 13 degrees to about 43 degrees on the base.

8. The miter saw of claim 1 further comprising a throat associated with the base and in a first position the throat is spaced from the material support surface and in a second position the throat is adjacent the material support surface.

9. The miter saw of claim 1 wherein the material support surface comprises a first material support surface and a second material support surface.

10. The miter saw of claim 1 further comprising a bevel support coupled with the table and including a bevel handle and a bevel locking mechanism comprising a lock pin, a cam lock coupled with the bevel handle and the lock pin, a detent pin and carrier coupled with the cam lock, and a detent override plate coupled with the bevel support that is capable of interfering with the detent pin and carrier.

11. The miter saw of claim 2, wherein the locking mechanism comprises
a. a spring coupled with the base and the material support surface; and,
b. a handle coupled with the base to secure the material support surface at a desired location with respect to the base.

12. A miter saw comprising:
a. a base;
b. a saw unit pivotally coupled with the base;
c. a table rotatably coupled with the base and having a throat that extends radially outward from an outer edge of the base;
d. a material support surface slidably moveable with respect to the base; and,
e. a return spring coupled with the base and with the material support surface to return the material support surface to a default position.

13. The miter saw of claim 12 further comprising a scale associated with the base and having a range of about −90 degrees to about +90 degrees.

14. The miter saw of claim 13 wherein an edge of the material support surface is positioned at a miter setting between about +/−40 degrees and about +/−55 degrees.

15. The miter saw of claim 14 wherein the edge of the material support surface is capable of moving within a range of about 13 degrees to about 43 degrees.

16. A miter saw comprising:
a. a base;
b. a scale associated with the base;
c. a saw unit pivotally coupled with the base and comprising a motor and a saw blade coupled with the motor;
d. a table rotatably coupled with the base;
e. a first material support surface moveable with respect to the base;
f. a second material support surface moveable with respect to the base; and,
g. a throat extending radially outward from the base between the first material support surface and the second material support surface.

17. The miter saw of claim 16 wherein the scale has a range of about −70 degrees to about +70 degrees.

18. The miter saw of claim 17 wherein an edge of the first material support surface is positioned at a miter setting of about +47 degrees.

19. The miter saw of claim 17 wherein an edge of the second material support surface is positioned at a miter setting of about −47 degrees.

20. The miter saw of claim 17 wherein the edge of the first material support surface and the edge of the second material support surface are each capable of moving a maximum of 23 degrees.
